(19) United States
(12) Patent Application Publication
(10) Pub. No.: US 2020/0300283 A1
(43) Pub. Date: Sep. 24, 2020

(54) CONNECTING ELEMENT FOR THE NON-DETACHABLE CONNECTION OF AT LEAST TWO COMPONENTS AND COMPOSITE ARRANGEMENT

(71) Applicants: ARNOLD UMFORMTECHNIK GmbH & Co. KG, Forchtenberg-Ernsbach (DE); BAYERISCHE MOTOREN WERKE AKTIENGESELLSCHAFT, München (DE)

(72) Inventors: Dominik FRÖHLICH, Zweiflingen (DE); Georg VOGEL, Ingelfingen-Eberstal (DE); Andreas PHILIPP, Forchtenberg-Ernsbach (DE); Patrick ROMINGER, Eppingen (DE); Klaus TRUETSCH, Neuenstein (DE)

(73) Assignee: ARNOLD UMFORMTECHNIK GmbH & Co. KG, Forchtenberg-Ernsbach (DE)

(21) Appl. No.: 16/768,520

(22) PCT Filed: Nov. 8, 2018
(86) PCT No.: PCT/EP2018/080685

§ 371 Date: May 29, 2020

(30) Foreign Application Priority Data
Dec. 1, 2017 (DE) 10 2017 221 681.6

(51) Int. Cl. F16B 9/00

(52) U.S. Cl. CPC F16B 9/01

(57) ABSTRACT

The present invention relates to a connecting element for non-detachably connecting at least two components by means of friction welding when the connecting element is rotated about a longitudinal axis of the connecting element. The connecting element includes a stem formed along the longitudinal axis with a stem face at a free end of the stem for penetrating at least one component, and a head connected to the stem for transmitting a torque about the longitudinal axis from a turning tool to the stem. The stem face has a stem end face which has a convex envelope with a blunt shape.

### CROSS REFERENCE TO RELATED APPLICATION

This application claims the benefit under 35 U.S.C. § 119(a) of German Application No. 10 2017 221 681.6 filed on Dec. 1, 2017 and is a national stage application under 35 U.S.C. § 371, of PCT/EP2018/080685, filed on Nov. 8, 2018, the contents of both are incorporated by reference herein in their entirety.

### BACKGROUND OF THE DISCLOSURE

### 1. Field of the Disclosure

The present invention relates to a connecting element for the non-detachable joining of at least two components by means of friction welding, as well as a composite arrangement with at least one connecting element which connects at least two components by means of friction welding.

### 2. Description of the Related Art

In the automated joining technology of metallic materials or components, the processing time or processing speed represents an essential productivity and cost factor. The demand for shorter processing times is therefore widespread. However, this demand can collide with technical boundary conditions, such as a high axial force on the joining element when joining by friction welding, which results in an increase in the processing time, or with the demand for a reduction in the quantity of metal chips when the joining element is turned.

From DE 10 2009 006 775 A1, a joining element for joining two workpieces attached to each other is known. A penetration section of the joining element has a spherical protrusion with a shape that is intended to facilitate penetration of the joining element into the first workpiece, such as an annular edge, a cutting edge or a gap-shaped recess.

The protrusion formation of the penetrating section causes the workpieces to be processed. Problems are associated with such processing, such as an increase in the amount of metal chips when turning the joining element and an insufficient strength of the connection produced.

From DE 10 2010 017 550 A1 discloses a connecting element for producing a friction welded connection of at least two plate-like components. The connecting element has a thread-shaped non-circular profile, through which displaced material is to be led away in a targeted manner.

Problems are associated with such processing, such as an increase in the amount of metal chips when the connecting element is turned and an increase in processing time required to an increase in the force applied and required for the connecting element.

### SUMMARY

It is therefore the object of the present invention to eliminate or at least partially eliminate the disadvantages described above with regard to a connecting element or joining element. In particular, it is the object of the present invention to provide a connecting element for the non-detachable joining of at least two components by means of friction welding as well as a composite arrangement with at least one connecting element, whereby a strength of the produced connection is improved and/or the production of the connection becomes more efficient and preferably a reduction of the material waste and/or the processing time resulting from the connection is achieved.

The preceding object is solved by the independent patent claims. Accordingly, the object is solved by a connecting element for the non-detachable joining of at least two components by means of friction welding with the features of claim 1 and by a composite arrangement with at least one connecting element, which connects at least two components by means of friction welding, with the features of claim 10. Further features and details of the invention are located in the dependent claims, the description and the drawings. Features and details which are described in connection with the connecting element are also valid in connection with the composite arrangement and vice versa, so that with regard to disclosure, reference is or can always be made to the individual aspects of the invention.

According to a first aspect, the object is solved by a connecting element for the non-detachable connection of at least two, in particular plate-shaped, components by means of friction welding when the connecting element is rotated about a longitudinal axis of the connecting element. The connection is to be understood as joining and the connecting element is a joining element or a friction-welded connecting element.

The connecting element comprises:
a stem formed along the longitudinal axis with a stem face at a free end of the stem for penetrating at least one component, and
a head connected to the stem for transferring a rotational torque about the longitudinal axis from a rotary tool to the shaft.

The stem face has a stem end face facing an outer area, which has a convex envelope and/or a convex shape. The envelope has a blunt shape or the shaft end face has a blunt shape.

In the present case, the terms “stem face” and “stem end face” are used equivalently with regard to the shape of the stem face or the stem end face or denote the same object. In addition, however, the front of the stem face may, unlike the stem end face, designate an inner area of the subject in question. If a reference is made to a course of the stem end face, a spatial 2D course is designated.

The envelope of the stem end face is to be understood as a surface which envelops the stem end face and whose points connect relative maxima of the stem end face. A relative maximum of the stem end face is preferably a mountain shaped or mound shaped elevation of the stem end face, wherein the stem end face may have a plurality of relative maxima. The relative maxima are preferably support points of a 2D interpolation surface, preferably the interpolation is linear or formed by splines. The 2D interpolation surface preferably connects the relative maxima or support points with each other and can thus form the envelope.

The envelope of the stem end face is convex if the envelope can be represented by a convex function in a section plane through the envelope. The section plane is preferably a longitudinal section plane comprising the longitudinal axis or a section plane perpendicular to the longitudinal axis. A function is convex if the following conditions are met for the entire range of the function:
a line segment between any two points in the graph of the function lies above the graph, i.e. in an inner area of the stem front or the envelope, and
the second derivative of the function is greater than zero

A surface, preferably the stem end face or its envelope, has a blunt shape if it is not pointed or not angular or not sharp-edged. Preferably, a surface has a blunt shape if, in the longitudinal or cross-sectional plane, the surface is represented or can be represented by a continuous function, the first derivative of which is continuous between the edges of the function.

A surface with a blunt shape can be regarded as a blunt surface. A stem end face with a projection having an annular edge, a cutting edge or a gap-shaped recess can be regarded as angular or sharp-edged, respectively, and does not have a blunt shape. In particular, the envelope of such a stem end face is not blunt.

According to a second aspect, the object is solved by a composite arrangement comprising at least two components and at least one connecting element according to the first aspect, by which the components are inseparably connected by friction welding.

The components are preferably plate-shaped and/or sheet metal shaped. However, the components may also be of a different configuration. For example, a first component, which is the first to be penetrated by the connecting element, may be plate-shaped. A second component, on which the first component is placed flat and joined by the connecting element, can be cuboid or cube-shaped or can be of any shape, provided it has a flat surface in some areas, against which the first component can rest.

When producing the connection, the connecting element can first be turned into at least one first component by rotation and axial pressure, moved through it and pressed into a subsequent component without penetrating it. The friction generated by the twisting and indentation causes the connecting element and the contacted surrounding component material to become hot, which makes the component material deformable, and to be displaced by the advancing connecting element, so that the connecting element is connected to the corresponding components by material adhesion while the components are held in contact with each other.

The formation of the connecting element surface which contacts, rubs against, softens, deforms and penetrates the components, in particular the formation of the stem end face and/or an external stem surface of the penetrating stem area, is largely responsible for generating the friction between the connecting element and the components and thus for the efficiency of the friction welding. The feature where the stem end face has i) a convex shape with an obtuse course and/or ii) a convex envelope with an obtuse course advantageously causes:
during the production of the connection, due to the surface structures or surface shapes which cause an increase in friction, a higher heat input occurs during contact between the stem end face and the component to be welded, thus reducing the process time.
a reduction in the material waste produced when producing the connection, because the absence of edges, especially sharp edges, or of tips reduces or even prevents the generation of chips when the connecting element is turned in, and
improved strength of the connection produced, because the displaced component material is not ejected in the form of flying chips, but in the form of material with reduced yield stress, which after cooling strengthens the connection between the connecting element and the components.

In a preferential further development of the invention, the stem end face has a blunt surface shape which has a surface structure deviating from a spherical shell segment with friction-enhancing elements. The stem end face preferably comprises at least one of the following friction-enhancing elements:
The stem end face has a plurality of recesses and projections, for example in the form of mountains, hills and valleys, which are evenly or possibly unevenly distributed.
The stem end face is configured like a golf ball. The term golf ball like describes a surface structure (golf ball structure) with depressions and projections, which can preferably have an envelope formed as a spherical shell segment. The depressions and projections can, for example, be evenly formed and/or recur periodically.
   The stem end face has an undulating outline in the longitudinal sectional plane and/or the transverse sectional plane. A wavy outline can be a sinusoidal shape, or a saw tooth shape (triangular shape) with cut-off or blunt corners, or a rectangular shape with cut-off or blunt corners.

The described surface structures or surface shapes increase the friction or the coefficient of friction between the stem end face and the components. The increased friction, in turn, causes increased heat development at the contact surface or friction surface and/or a stronger abrasion effect and can advantageously facilitate the penetration of the connecting element and cause an increased efficiency of the friction welding as well as a reduction of the processing time or cycle time without producing material waste, e.g. chips.

In a preferential further development of the invention, the envelope of the stem end face has a round or arc-shaped outline in the longitudinal section plane. This has the advantage of reducing the amount of material waste produced during the manufacture of the connection, because the absence of edges, especially sharp edges, or of points reduces or even avoids the generation of chips when the connecting element is screwed in.

Overall, the round or blunt shape of the penetrating portions of the connecting element, including the stem end face and the outer surface of the forming area and the friction-enhancing elements provided in these portions, ensures that increased friction and, consequently, increased efficiency of the friction welding is achieved while avoiding entanglement of the penetrating portions.

According to a further preferential further development of the invention, the envelope of the stem end face is rotationally symmetrical about the longitudinal axis and/or has a circular outline in the cross-sectional plane. This can advantageously facilitate production and reduce production costs (a rotationally symmetrical element is easier and cheaper to produce than a non-rotationally symmetrical element).

In a further preferential further embodiment of the invention, the envelope of the stem end face has a circular or parabolic or elliptical outline in the longitudinal plane. In combination with the rotationally symmetric shape, such an outline has the advantageous effect of good friction and at the same time avoiding waste of material, while at the same time the production is easy and the production costs are low.

According to a preferential further embodiment of the invention, the stem comprises at least two sections including a mold section starting from the free end of the stem and a retaining section starting from the head of the stem. The retaining section forms an upper part of the stem which retains the head, and the mold section forms a lower part of the stem which adjoins the stem face and which, together with the stem face, contributes to the generation of increased friction between connecting element and components and thus to an increased friction welding effect.

In a preferential further development of the invention, the mold section has in the cross-sectional plane a polygonal, i.e. polygonal or polygonal, outline with rounded corners, preferably the distances between the corners i) being of equal length in order to cause a uniform rotary movement during friction welding, and/or ii) being straight and/or curved in some areas in order to cause increased friction between connecting element and components while at the same time avoiding waste.

According to a further preferential further embodiment of the invention, the polygon-shaped outline of the mold section has at least three, four or six corners. This is advantageous in that it increases the friction between the connecting element and the components while at the same time reducing waste and lowering the production costs of the connecting element.

In a preferential further embodiment of the invention, an outer surface of the mold section is flat in certain areas, preferably the outer surface of the mold section comprising at least three flat or approximately flat surface sections. An approximately flat shape is to be understood as a slightly curved shape which deviates only slightly from the flat shape. This will advantageously result in a blunt course of the outer surface or contact surface and at the same time in increased friction between the connecting element and components, while at the same time avoiding waste.

In case of a preferred further embodiment of the invention, the mold section is cylindrical or approximately cylindrical in shape. In this context, a cylindrical form is to be understood as a form in which, in a longitudinal sectional plane, the outline of the mold section runs parallel or approximately parallel to the longitudinal axis, where the mold section does not necessarily have to be rotationally symmetrical with respect to the longitudinal axis.

Furthermore, according to a preferred further embodiment of the invention, the mold section has an outline in the cross-sectional plane which is arc-shaped or rectilinear in certain areas. Preferably, the mold section in the cross-sectional plane has an outline which is alternately rectilinear and arc-shaped in areas. The largely round shape, which nevertheless deviates from a circular shape, can advantageously result in increased friction while at the same time reducing the material waste produced during the manufacture of the connection.

In the case of a preferred further embodiment of the invention, the outer surface of the mold section is profiled around the longitudinal axis in the circumferential direction and exhibits in particular radial grooves, notches or depressions. Such a profile is characterized in the cross-sectional plane by corresponding radial variations of the circumferential contour. The profiling including recesses of any kind preferably has a rounded shape or contour in the cross-sectional plane. The largely round shape, which nevertheless has friction-enhancing elements, can advantageously result in increased friction and at the same time reduce the amount of material waste produced when producing the connection.

Alternatively, the outer surface of the mold section is preferably smooth around the longitudinal axis in the circumferential direction. In this way an additional reduction of the material waste produced during the manufacture of the connection and/or a uniform transmission of force over the outer surface of the mold section and a reliable friction-welded connection with short cycle times can be achieved.

According to a further preferred further embodiment of the invention, the outer surface of the mold section is tripolygonal in shape. Tripolygonal here means in particular that the outer surface of the mold section comprises three polygonal surfaces, preferably four corner surfaces or rectangular surfaces. This is advantageous for rolling in the first component and thus for increased frictional heat and improved screw-in behavior of the connecting element. In addition, it may preferably be provided that the connecting element, excluding the tip, i.e. the stem end face, is electroplated.

In a preferred further embodiment of the invention, an outer surface of the retaining section is cylindrical or approximately cylindrical or conical and in particular smooth. This is advantageous in order to facilitate the screwing in or penetration of the connecting element and the transfer of the plasticized component material.

Furthermore, according to a preferred further embodiment of the invention, a transition between i) the stem face and the outer surface of the mold section and/or ii) between the mold section and the retaining section is rounded. This additionally causes a rounded or blunt shaping of the sections of the connecting element penetrating into the components. This is advantageous in ensuring that there are no edges or points in the relevant area of the stem external face.

In a preferred further embodiment of the invention, a lower surface of the head facing the stem has a circumferential groove. This configuration corresponds to a groove and enables the accommodation of component material displaced or formed during the manufacture of the connection so that an outer edge on the bottom of the head lies flat on the upper of the interconnected components and additionally seals the resulting friction-welded connection against moisture penetration.

In a further preferred embodiment of the invention, an upper side of the head facing away from the stem features a torque coupler for transmitting the torque from the rotary tool to the head of the connecting element during friction welding. Preferably, the torque coupler has radial grooves, recesses or projections. This is advantageous for efficient torque transmission to the head and for simple and cost-effective production of the entire connecting element. Such a torque coupler is particularly suitable for automated applications, because the rotary tool does not need to be positioned very precisely when it is lowered onto the connecting element head to provide effective torque transmission to the connecting element.

In a preferential further embodiment of the invention, the connecting element is formed of a steel alloy, preferably of a screw-quenching and tempering material, or of a manganese- and/or boron-containing steel, in particular 20MnB4, 23MnB4 or 22MnB5. Alternatively, the connecting element is made of a Ti alloy. In particular, the connecting element has a martensitic structure. Alternatively, the connecting element has an austenitic microstructure, which is known to have a high strength. The surface of the connecting element is preferably hardened, for example by carburization, which creates a particularly resistant penetration layer.

A connecting element with a surface coating is also preferred. This is preferably applied by means of electroplating, or by a chemical nickel method, by plasma spraying, kinetic cold gas compacting, flame spraying, hard chromium plating, or by physical vapor deposition. For a particularly high hardness, the connecting element comprises at least in some areas high-carbon steel, in particular with a cementitious structure.

In accordance with a further preferred further embodiment of the invention, at least the stem end face, if necessary, also the stem including the mold area and retaining section, is electrogalvanized, preferably a layer of a material comprising zinc or a zinc-nickel compound being electrochemically applied at least to the stem end face. It is advantageous to produce a particularly hard or resistant layer on the stem end face and/or the mold area. Ideally, the complete connecting element is completely electroplated. A bare tip, i.e. a stem end face that is not electroplated, also enables a reliable welding method.

In a preferred further embodiment of the invention, a length of the mold section is about two to three times smaller than a length of the stem. This allows advantageously short cycle times to be achieved in friction welding, with a reliable seal being ensured by the retaining section with a circular cross-section.

After a preferential further embodiment of the invention, a respective component is formed from a metal or a metal alloy. Friction welding is thus advantageously made possible at all.

According to a further preferred further embodiment of the invention, at least one of the components, in particular at least a first component penetrated by the connecting element, is formed from a material which comprises a non-ferrous metal, preferably copper, aluminum or brass and/or has a lower material hardness than the connecting element. It is equally preferred if at least one of the components is made of plastic, in particular of thermoplastic or thermosetting plastic. This is advantageous because it facilitates the penetration of the connecting element into the components, friction welding can be made more efficient and cycle times can be shortened.

In a preferential further embodiment of the invention, the components are each configured as metal sheets or metal plates. Preferably, the components may each be unperforated or may have holes smaller in diameter than i) the largest diameter of the mold section and/or ii) the diameter of the retaining section. The advantage of this is that a hole created during friction welding and/or filled by the connecting element is reliably sealed by the retaining section of the stem starting from the head after completion of the friction welded connection. For this purpose, the retaining section may have a larger diameter than a maximum diameter of the mold section.

After a preferential further embodiment of the invention, the material of the at least one first component has a lower hardness than the material of the other components. This advantageously facilitates the penetration of the connecting element into the components, friction welding can be made efficient and cycle times can be shortened.

Furthermore, after a preferential further embodiment of the invention, at least one of the components not arranged as the first component is made of steel. This is advantageous in order to achieve an increased strength of the composite arrangement, while still not hindering or impairing the penetration of the connecting element during friction welding.

According to a preferential further embodiment of the invention, a total thickness of the components is at most as large as a length, i.e. axial extension, of the retaining section of the connecting element. This is advantageous to ensure complete penetration of the components by the connecting element in case the front part of the connecting element, including the stem face and mold section, is abraded or melted off during friction welding.

### BRIEF DESCRIPTION OF THE DRAWINGS

Connecting elements according to the invention are explained in more detail below on the basis of drawings. They each show schematically:

FIG. 1 shows a first embodiment of the connecting element in a side view.

FIG. 2 shows a first embodiment of the connecting element in a top view.

FIG. 3 shows a first embodiment of the connecting element in a bottom view.

FIG. 4-7 shows the processing steps of a composite arrangement with two components and a composite element by friction welding.

FIG. 8 the first embodiment of the connecting element in a longitudinal sectional plane sectional view through the stem face.

FIG. 9 the first embodiment of the connecting element in a cross-sectional plane sectional view through the stem face.

FIG. 10 a second embodiment of the connecting element in a cross-sectional plane section view through the stem face.

FIG. 11 shows a third embodiment of the connecting element in a side view.

FIG. 12 a third embodiment form of the connecting element in cross-sectional plane section views through the retaining section and the forming section.

FIG. 13 a third embodiment of the connecting element in a longitudinal sectional plane sectional view.

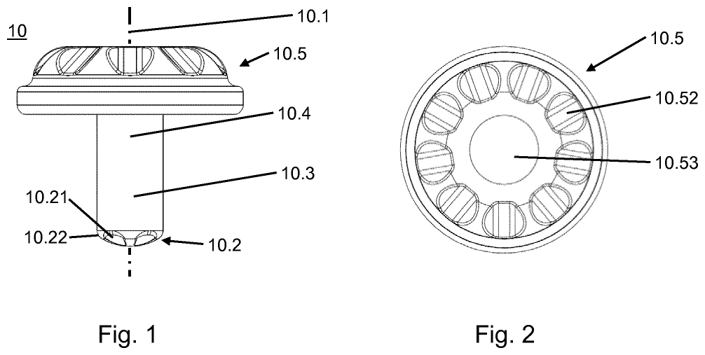

Elements with the same function and mode of operation are each provided with the same reference signs in the FIGS. 1 to 13 shown.

### DETAILED DESCRIPTION

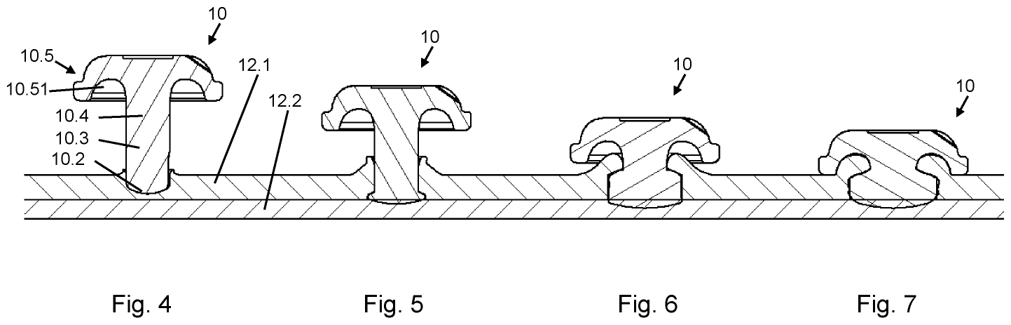

FIG. 1 shows a first embodiment of connecting element 10, which is used for the non-detachable connection of two components 12.1, 12.2 by friction welding, which is used in the FIG. 4-7, when turning the connecting element 10 around a longitudinal axis 10.1 of the connecting element 10.

The connecting element 10 comprises:
a stem 10.2-10.4 formed along the longitudinal axis 10.1 with a stem face 10.2 at a free end of the stem 10.2-10.4 for penetrating a component 12.1, and
a head 10.5 connected to the stem 10.2-10.4 to transmit a torque about the longitudinal axis 10.1 from a turning tool to the stem 10.2-10.4.

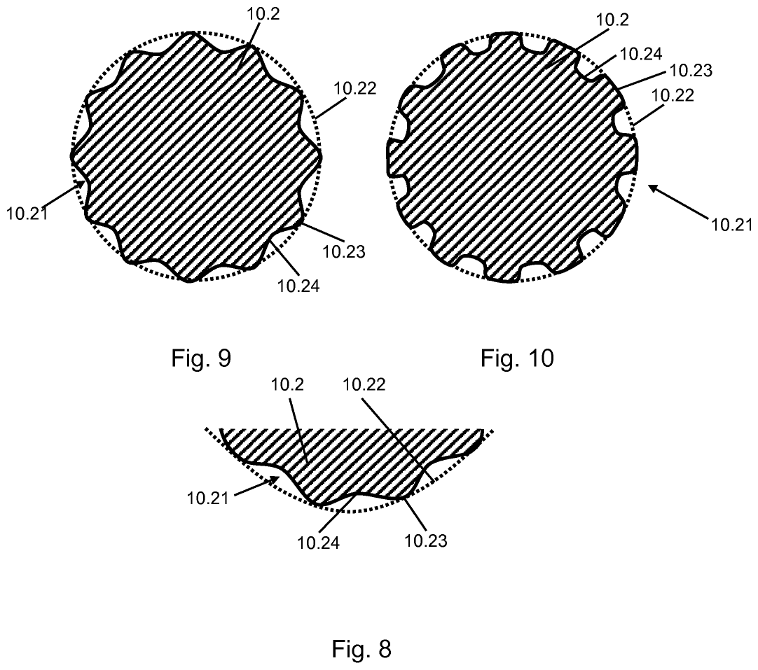

The stem face 10.2 has a stem end face 10.21 which has a convex envelope 10.22 with a blunt course. The envelope 10.22 of the stem end face 10.21 is to be understood as a surface which envelops the stem end face 10.21 and whose points connect relative maxima of the stem end face 10.21 (see FIG. 8-10). The relative maxima form points of a 2D interpolation surface connecting the relative maxima or points, which represents the envelope 10.22.

In the front view of the connecting element 10 shown in FIG. 1 the envelope 10.22 corresponds to a contour of the stem end face 10.21. In contrast to this, in the sectional views of the stem face 10.2 shown in FIGS. 8 and 9, the envelope 10.22 differs from the contour 10.21 of the stem face 10.2 and is thus clearly recognizable.

In the plan view of the connecting element 10 shown in FIG. 2, the head 10.5 is recognizable, whereby an upper side of the head 10.5 facing away from the stem 10.2-10.4 has a circular flat pressure surface 10.53 in its center and a torque coupler 10.52 around it on the outside for transmitting the torque from a turning tool to the head 10.5 during friction welding. The torque coupler comprises radial grooves or recesses 10.52 in which a corresponding counterpart of the turning tool (not shown), for example radial projections of a face of the turning tool, cooperates with the torque coupler or engages in the radial grooves when the turning tool is lowered axially to turn the connecting element 10. The flat pressure surface 10.53 is provided for axial pressure on the connecting element 10.

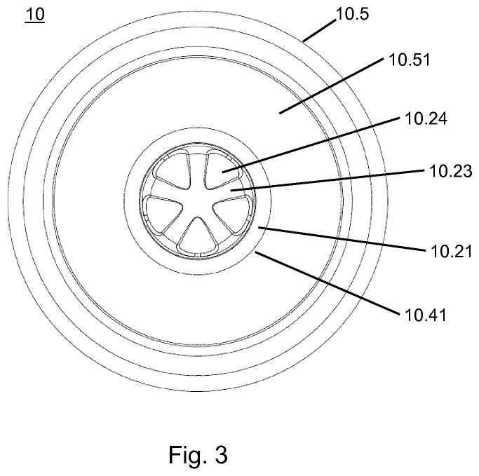

In the view from below of the connecting element 10 shown in FIG. 3, the stem end face 10.21 is visible, which has crests or projections 10.23 and troughs or depressions 10.24, which form friction-increasing elements of the stem end face 10.21.

The stem end face 10.21, shown as an example in FIGS. 8, 9, has a blunt shape in that it is not pointed or angular. In other words, the stem end face 10.21 can be represented or shown in the longitudinal section plane (FIG. 8) or cross-section plane (FIG. 9) by a continuous function, the first derivative of which is continuous between the edges of the function, which are also edges of the stem end face 10.21.

FIG. 8 shows in a longitudinal sectional plane sectional view through the stem face 10.2 a first formation of the stem end face 10.21 with friction increasing elements. Here it can be seen that the contour 10.21 of the stem face 10.2 has a plurality of projections or wave crests 10.23 and of depressions or wave valleys 10.24 which are evenly distributed. In FIG. 9, in which in a cross-sectional plane sectional view through the stem face 10.2 the contour of the stem face 10.2 or the stem end face 10.21 is shown, similar friction increasing elements (uniformly distributed projections 10.23 and depressions 10.24) are recognizable. In general, the stem end 10.2 has a wave-shaped contour 10.21 in sectional views through the stem end 10.2, whereby the height or amplitude of the wave is exaggerated in the figures shown for illustrative purposes, i.e. greater than according to a real scale.

FIG. 10 shows in a longitudinal sectional plane sectional view through the stem end 10.2 a further formation of the stem end face 10.21 with friction-enhancing elements. In this embodiment the contour 10.21 of the stem face 10.2 shows an undulating course with a rectangular shape, whereby the corners are cut off or blunt.

The embodiment of the connecting element 10 shown in FIGS. 8-10 have a substantial friction welding effect due to the blunt course of the stem end face 10.21 and/or the envelope 10.22 in conjunction with the stem face 10.2, which has a surface structure with friction-enhancing elements 10.23, 10.24. A similar effect (friction, heating, material melting, no waste generation) is also produced by a (not shown) golf ball structure of the stem end face 10.21.

In the side view of the connecting element 10 shown in FIG. 11, it can be seen that the stem 10.2-10.4 comprises a mold section 10.3 starting from the free end of the stem and a retaining section 10.4 starting from the head 10.5 of the stem. The retaining section 10.4 thus forms an upper part of the stem which holds the head 10.5, and the mold section 10.3 forms a lower part of the stem which adjoins the stem face 10.2 and, together with the stem face 10.2, contributes to the generation of increased friction between the connecting element 10 and components 12.1, 12.2 and thus to an increased friction welding effect.

The stem face 10.2 shown in FIG. 11, 13 has a blunt stem end face 10.21 without a wave-like shape, but with a fine-grained, friction-enhancing surface structure which produces the desired effect of an improved friction welding.

The retaining section 10.4 shown in FIG. 11 has a larger diameter than a maximum diameter of the mold section 10.3. This has the advantage that a hole (through bore) created or spread out in the first component 12.1 during friction welding or a pilot hole created in the second component 12.2 after completion of the friction welded connection is reliably sealed by the retaining section 10.4 starting from the head 10.5. In contrast to this, the connecting element 10 shown in FIG. 1 has a stem 10.2-10.4 in which the mold section 10.3 and the retaining section 10.4 do not or only slightly differ from each other.

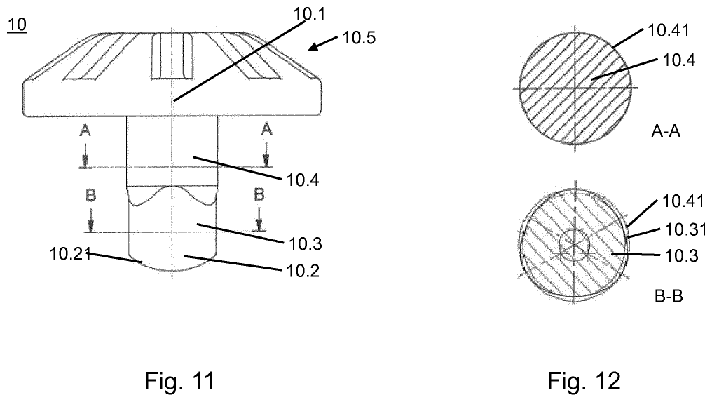

In the cross-sectional plane sectional views through the retaining section 10.4 (section A-A) and through the mold section 10.3 (section B-B) shown in FIG. 12, it can be seen that the retaining section 10.4 has a cross-section with a circular contour 10.41 and the mold section 10.3 has a cross-section with a contour 10.31 which is not circular but slightly undulating. The cross-sectional contour 10.31 of the mold section 10.3 is friction-increasing and thus improves the friction welding and reduces the cycle times. In addition, it can be seen that the largest diameter of the forming section contour 10.31 is larger than the diameter of the retaining section contour 10.41. Thus, after the production of a friction welded connection, the outer circumference of the mold section 10.3 lies flat against the surge of a hole produced in the upper component 12.1 and thus ensures a reliable sealing of the friction welded connection produced.

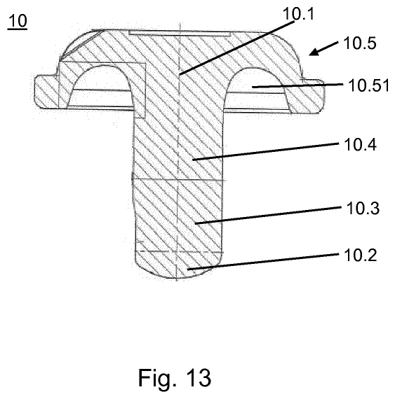

In the longitudinal sectional plane sectional view through the connecting element 10 shown in FIG. 13, the overall structure of the connecting element 10 is visible. The stem 10.2-10.4 formed along the longitudinal axis 10.1 has a curved and blunt stem face 10.2 and is connected with a head 10.5. The stem 10.2-10.4 has a mold section10.3 in a lower part connected to the stem face 10.2 and a retaining section 10.4 in an upper part connected to the head 10.5. The bottom of the head 10.5 facing the stem 10.2-10.4 has a circumferential groove 10.51. This configuration corresponds to a chamfer and makes it possible, advantageously during friction welding, to accommodate molten component material so that an outer edge on the bottom of the head 10.5 rests flat on the upper 12.1 of the interconnected components 12.1, 12.2 and additionally seals the friction welded connection against moisture penetration.

In the case of the FIG. 4-7, the connecting element 10 is first turned by rotation and axial pressure into a first component 12.1 (FIG. 4), which consists of aluminum, moved through it and pressed into a following, second component 12.2 made of steel without penetrating it (FIG. 5). Due to the friction created by the turning and pressing in, the connecting element 10 and the contacted, surrounding component material become hot, whereby the flow stress of the component material is lowered and the material is displaced by the connecting element 10 (FIG. 6), so that the connecting element 10 is bonded to the components 12.1, 12.2, while the components 12.1, 12.2 are held in contact with each other. The molten component material rises up the side of the connecting element 10 and penetrates into the circumferential groove 10.51 on the bottom of the head 10.5. Finally, by means of rotation and axial pressure, a compression of the stem 10.2-10.4 is effected, bringing the head 10.5 of the connecting element 10 into an end position on the first component 12.1 (FIG. 7).

### LIST OF REFERENCE SIGNS

10 Connecting element
10.1 Longitudinal axis of the connecting element
10.2 Stem face of the connecting element
10.21 Stem end face, contour of the stem face
10.22 Envelope of the stem end face or stem face
10.23 Projections, crest of stem end face or stem face
10.24 Recess, trough of stem end face or stem face
10.3 Mold section of the connecting element
10.31 Contour of the mold section
10.4 Retaining section of the connecting element
10.41 Contour of the retaining section
10.5 Head of the connecting element
10.51 Circumferential groove at the bottom of the head
10.52 Torque coupler, radial groove on top of head
10.53 Pressure surface on top of the head
12.1 First component to be connected
12.2 Second component to be connected

What is claimed is:

1. A connecting element for non-detachably connecting at least two components by means of friction welding when the connecting element is rotated about a longitudinal axis of the connecting element, comprising:
a stem formed along the longitudinal axis with a stem face at a free end of the stem for penetrating at least one component, and
a head connected to the stem for transferring a torque about the longitudinal axis from a rotary tool to the stem wherein the stem face has a stem end face which has a convex envelope with a blunt shape.

2. The connecting element according to claim 1, further comprising at least one of the following features:
wherein the stem end face has a plurality of recesses and projections;
wherein the stem end face is configured as a golf ball shape.

3. The connecting element according to claim 1, wherein the convex envelope of the stem end face has a round or arc-shaped outline in a longitudinal section plane.

4. The connecting element according to claim 1, further comprising at least one of the following features:
wherein the stem comprises a mold section starting from the free end of the stem and a retaining section starting from the head of the stem;
wherein the mold section has a polygon-shaped outline with rounded corners in a cross-sectional plane;
wherein the polygonal-shaped outline of the mold section has at least three corners; and
wherein the retaining section has a diameter that is larger than a maximum diameter of the mold section.

5. The connecting element according to claim 4, wherein the mold section has an outline in the cross-sectional plane which is regionally alternately rectilinear and arc-shaped.

6. The connecting element according to claim 4, further comprising at least one of the following features:
in each case a flat surface section of the mold section is polygon-shaped, wherein in each case one polygon is preferably triangular or quadrangular;
an outer surface of the mold section is profiled about the longitudinal axis in a circumferential direction of the mold section;
the outer surface of the mold section is tripolygonal in shape;
the outer surface of the mold section i) has radial grooves, notches or depressions or ii) is smooth.

7. The connecting element according to claim 4, further comprising at least one of the following features:
the retaining section is cylindrical or approximately cylindrical or conical;
a transition between at least i) the stem face and the mold section or ii) between the mold section and the retaining section is of rounded configuration.

8. The connecting element according to claim 1, further comprising at least one of the following features:
the a bottom of the head facing the stem has a circumferential groove;
an upper side of the head facing away from the stem has a torque coupler for transmitting the torque from the rotary tool to the head;
wherein the torque coupler comprises a plurality of radial grooves, recesses or projections.

9. The connecting element according to claim 4, further comprising at least one of the following features:
wherein the connecting element is formed from a steel alloy, preferably from a screw tempering material;
wherein at least the stem end face is electrogalvanized;
a length of the mold section is about two to three times smaller than a length of the stem.

10. The connecting element according to claim 1, wherein the connecting element, except for the stem end face, is electroplated.

11. A composite arrangement comprising:
at least two components and
at least one connecting element for non-detachably connecting at least two components by means of friction welding when the connecting element is rotated about a longitudinal axis of the connecting element, comprising
a stem formed along the longitudinal axis with a stem face at a free end of the stem for penetrating at least one component, and
a head connected to the stem for transferring a torque about the longitudinal axis from a rotary tool to the stem,
wherein the stem face has a stem end face that has a convex envelope with a blunt shape by which the components are non-detachably connected by means of friction welding.

12. The composite arrangement according to claim 11, further comprising at least one of the following features:
a respective component is formed from a metal or a metal alloy;
at least one of the components, is formed from a material which comprises at least a non-ferrous metal, preferably copper, aluminum or brass or has a lower material hardness than the connecting element;
at least one of the components not arranged as first components is made from steel;
a total thickness of the components is at most as great as a length of a retaining section of the connecting element.

13. The connecting element according to claim 2, wherein the convex envelope of the stem end face has a round or arc-shaped outline in a longitudinal section plane.

14. The connecting element according to claim 9, further comprising a layer of a material comprising zinc or a zinc-nickel compound that is electrochemically applied at least to the stem end face.
